(19) United States
(12) Patent Application Publication
(10) Pub. No.: US 2026/0111244 A1
(43) Pub. Date: Apr. 23, 2026

(54) REUSABLE INVOKED USER EXPERIENCES VIA PROMPTING ACROSS MULTIPLE APPLICATIONS

(71) Applicant: Microsoft Technology Licensing, LLC, Redmond, WA (US)

(72) Inventors: Luke Matthew BENDER, New York, NY (US); Desana DAXNEROVÁ, Dublin (IE); Timothy John HEENEY, Burnet, TX (US); Natasha Kay SUN, Plano, TX (US); Baiju K. NAIR, Renton, WA (US); Kevin Hin-Yeung CHAN, Bellevue, WA (US); Wei CHEN, Sammamish, WA (US); Gauri RAMESH, Redmond, WA (US); Ruchit PALRECHA, Redmond, WA (US); Sarah Mahejabeen RAHMAN, Laurel, MD (US)

(21) Appl. No.: 18/920,521

(22) Filed: Oct. 18, 2024

(51) Int. Cl. G06F 9/451; G06F 9/54; G06N 3/0475

(52) U.S. Cl. CPC G06F 9/451; G06F 9/547; G06N 3/0475

(57) ABSTRACT

Example implementations relate to methods, apparatuses, and computer-readable media for providing reusable user experience components for interacting with a generative artificial intelligence (AI). An AI service hosted in a network receives a first prompt from an application or a user thereof to a generative AI. An orchestration layer of the generative AI configured to generate an execution plan and chain-of-thought for the prompt identifies a first skill from a skill library that best answers the prompt. The AI service obtains a schema for the first skill and returns the schema to a control loader of the application that invokes pre-written code for the first skill with inputs specified in the schema to generate a user interface component. The AI service provides a context of the user interface component to the generative AI.

### BACKGROUND

Generative artificial intelligence (AI) has rapidly advanced and has shown promise in providing interactions between human users and computer systems. For example, chat bots are a form of generative AI that uses a large language model (LLM) to respond to prompts from a user. Such chat bots have been incorporated into various customer facing applications to provide services such as searching, instructions, troubleshooting, and navigation.

Chat bots conventionally use natural language prompts. The natural language prompts provide appropriate input to a large language model to produce textual responses. This correlation between natural language prompts and large language models has made text based chat interfaces the dominant form of interaction between users and generative AI.

Interactions between users and computer systems, however, are typically not limited to textual interactions. Accordingly, improvements to the user experience of interacting with generative AI can improve performance of such computer systems.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to an apparatus, including: one or more memories storing computer executable instructions; and one or more processors coupled with the one or more memories and, individually or in combination, configured to: execute an application having an interface with a generative AI; send a prompt from the application to a network service hosting the generative AI; receive a schema specifying pre-written code for a user interface component and input to the user interface component selected by the generative AI; execute the user interface component to interact with a user of the apparatus; and inform the generative AI of context of the user interactions.

In some aspects, the techniques described herein relate to an apparatus, including: one or more memories storing computer executable instructions; and one or more processors coupled with the one or more memories and, individually or in combination, configured to: receive a first prompt from an application or a user thereof to a generative artificial intelligence (AI); identify, by an orchestration layer of the generative AI configured to generate an execution plan and chain-of-thought for the prompt, a first skill from a skill library that best answers the prompt; obtain a schema for the first skill; return the schema to a control loader of the application that invokes pre-written code for the first skill with inputs specified in the schema to generate a user interface component; and provide a context of the user interface component to the generative AI.

In some aspects, the techniques described herein relate to a method including: receiving a first prompt from an application or a user thereof to a generative AI; identifying, by an orchestration layer of the generative AI configured to generate an execution plan and chain-of-thought for the prompt, a first skill from a skill library that best answers the first prompt; obtaining a schema for the first skill; returning the schema to a control loader of the application that invokes pre-written code for the first skill with inputs specified in the schema to generate a user interface component; and providing a context of the user interface component to the generative AI.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example of an architecture for a system to provide reusable user experience components for interaction with a generative artificial intelligence (AI), in accordance with aspects described herein.

FIG. 2 is a diagram of a user interface of an example client application including examples of user experience component, in accordance with aspects described herein.

FIG. 3 is a message diagram illustrating example communications of a system for providing reusable user experience components for interaction with a generative AI, in accordance with aspects described herein.

FIG. 4 is a message diagram 400 illustrating example communications of a user device for presenting reusable user experience components for interaction with a generative AI, in accordance with aspects described herein.

FIG. 5 is a schematic diagram of an example of an apparatus (e.g., a computing device) for providing reusable user interface components for interaction with a generative AI model.

FIG. 6 illustrates an example of a user device presenting reusable user experience components for interaction with a generative AI, in accordance with aspects described herein.

FIG. 7 is a flow diagram of an example of a method for providing reusable user experience components for interaction with a generative AI.

FIG. 8 is a flow diagram of an example of a method for presenting reusable user experience components for interaction with a generative AI.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to reusable user experience components for interaction with a generative artificial intelligence (AI). Although text based interfaces such as chat windows provide simple interactions with generative AI, text based interfaces may not be sufficient for some tasks. For example, some user inputs (e.g., selections from lists, positional information, or drawings) may be more efficiently entered via other user interface components. Similarly, outputs such as audio and video may be enhanced with dedicated user experience components.

One approach to adding user experience components to an application using generative AI would be to program the specific user interface components within the application, and allow the generative AI to execute user interface components as needed. There are two technical problems with this approach. First, the specific programming for an application may be labor intensive to create a solution for each application. The general applicability of the generative AI model may be reduced and user experiences across applications may be inconsistent. Second, a specific user interface component for an application may not provide sufficient context for the generative AI. That is, when a user interacts with a user interface of the application, the generative AI may not have access to the interactions and changes that are made within the specific user interface (i.e., outside of the generative AI interface). The missing context may limit the ability of the generative AI to engage in further interactions after the user experience.

In an aspect, the present disclosure provides reusable invoked user experiences via prompting across multiple applications. In some implementations, the user experiences are skills that are associated with pre-written code for generating a user interface component. A user or application can provide a prompt to a generative AI tool. For example, the prompt may be a text prompt generated by the user, a selection of a button on a user interface of an application, or other action within the application. The generative AI tool may include an orchestrator that identifies a first skill from a skill library that best answers the prompt. The skill library may include the skills associated with the user experiences as well as other skills that the generative AI may perform. The skills associated with a user experience may be defined by a schema that defines inputs to the pre-written code for the skill. The orchestrator may return the schema to a control loader of the application that invokes the pre-written code with the inputs specified by the schema to generate the user interface component. The user may then interact with the user interface component. The user interface component is configured to provide context information to the generative AI. For instance, the user interface component may report events performed by the user to the generative AI to complete the skill or update the context of the generative AI for a further prompt from the user.

Generative AI may refer to various models that are trained to generate content in response to a prompt. A generative AI model is trained on a corpus of works and the model generates a similar work based on the prompt. For example, Large Language Model (LLM) is a term that refers to artificial intelligence or machine-learning models that can generate natural language texts from large amounts of data. Large language models use deep neural networks, such as transformers, to learn from billions or trillions of words, and to produce texts on any topic or domain. Large language models can also perform various natural language tasks, such as classification, summarization, translation, generation, and dialogue. A small language model may be similar to a LLM, but trained or pruned to focus on a particular task or domain. Accordingly, a small language model may produce similar results to an LLM using fewer computing resources. Additionally, generative AI models include text-to-image and text-to-video AI models. Further, generative AI models may include multi-modal models that receive different types of input such as text, audio, images, and/or video. As used herein, the term “prompt” refers to any input into a generative AI model without being limited to a particular modality.

Implementations of the present disclosure may realize one or more of the following technical effects. Firstly, invoking pre-written code for a user interface component for a skill based on a schema identified by an orchestration layer allows re-use of user experience components between different applications having generative AI interfaces. Accordingly, the user experience of interacting with a generative AI can be easily enhanced beyond a chat interface. Additionally, the re-use of the user experience across applications increases predictability of the experience and facilitates ease of use. Further, the user experience components may be built, debugged, and optimized with fewer programming resources than separate user experience components for each application. In some implementations, the user interface can be reused between a traditional UI application, such as an productivity application and the generative UI experience, thereby streamlining the user's workflow when using both. A development team using this system can leverage their existing experience building traditional UI applications when building for generative UI, thereby improving time to market and user experience. Secondly, bi-directional context sharing between a user interface component and a generative AI allows the generative AI to maintain state for complex interactions that involve graphical interactions. For example, a user may interact with the generative AI during a user experience by manipulating an object such as an image, chart, or spreadsheet. The user interface component may provide the context of these interactions to the generative AI model, for example, in a multi-modal prompt. Accordingly, the ability of the generative AI to interact with a user is improved by facilitating interactions other than text. Additionally, the user's interaction with the UI element gives additional information and context for the generative AI to further enhance the experience. For example, the generative AI may interactively correct input errors in those elements or make inferences based on partial information added, such as suggesting a username based on first and last names. Accordingly, the bi-directional context sharing may improve the performance of the generative AI and the user interface.

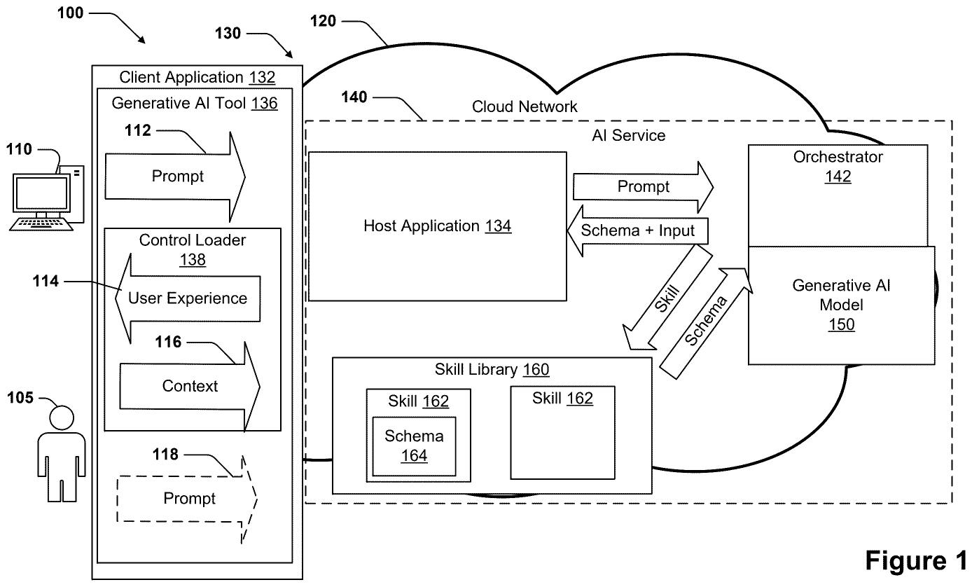

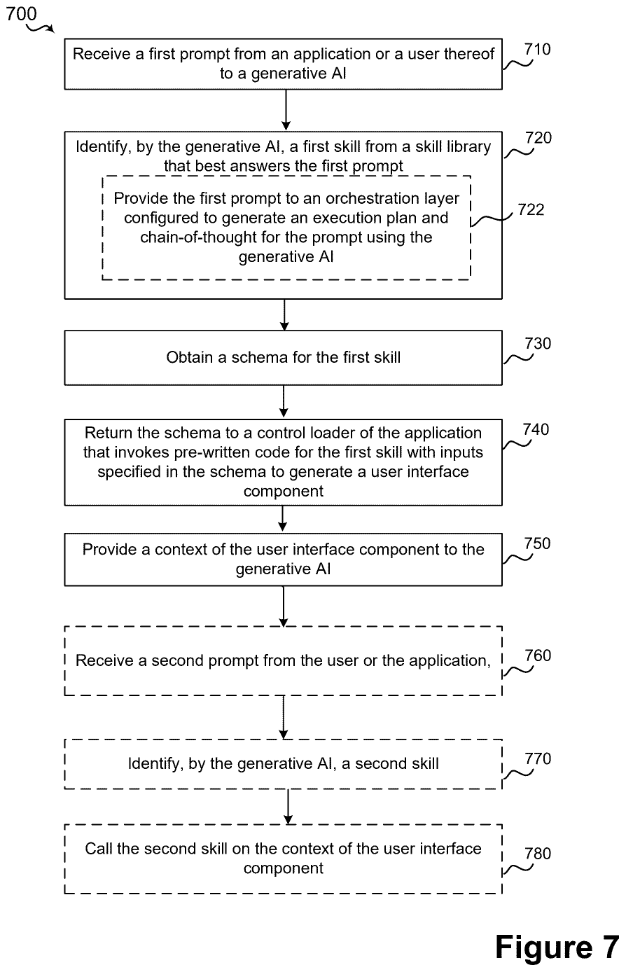

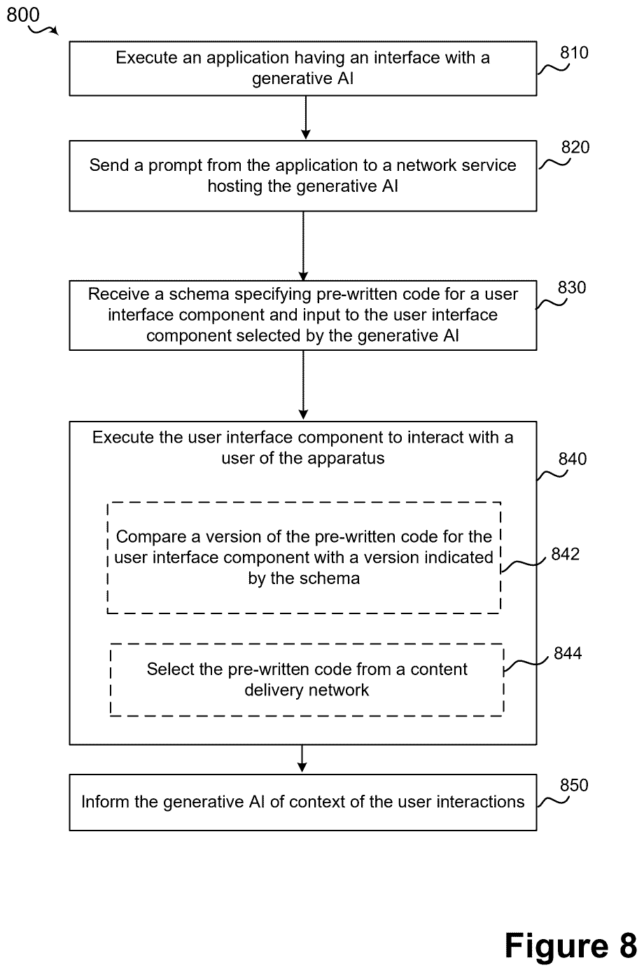

Turning now to FIGS. 1-8, examples are depicted with reference to one or more components and one or more methods that may perform the actions or operations described herein, where components and/or actions/operations in dashed line may be optional. Although the operations described below in FIGS. 7 and 8 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a conceptual diagram 100 of an example of an architecture for a system 120 to provide reusable user experience components for interaction with a generative AI model 150. The system 120 may be, for example, a cloud network including computing resources that are controlled by a network operator and accessible to public clients such as a user device 110 operated by a user 105. For example, the system 120 may include a plurality of datacenters 122 that include computing resources such as computer memory and processors. In some implementations, the datacenters 122 may host a compute service that provides computing nodes on computing resources located in the datacenter. The computing nodes may be containerized execution environments with allocated computing resources. For example, the computing nodes may be virtual machines (VMs), process-isolated containers, or kernel-isolated containers. The nodes may be instantiated at a datacenter 122 and imaged with software (e.g., operating system and applications for a service). The system 120 may include edge routers that connect the datacenters 122 to external networks such as internet service providers (ISPs) or other autonomous systems (ASes) that form the Internet.

In an aspect, the system 120 provides one or more hosted applications 130 supported by an AI service 140. For example, a hosted application 130 may include a client application 132 that executes on a user device 110 and a host application 134 that executes on the system 120. The client application 132 may operate independently on the client device 110, but some features may be available only through the system 120. In some implementations, the system 120 hosts the generative AI model 150 and provides access to the generative AI model 150 via the host application 134. For instance, the system 120 may provide a generative AI tool 136 within the client application 132. The generative AI tool 136 may be referred to as an AI assistant, Co-Pilot, or other name. In some implementations, the generative AI tool 136 may include a standard interface (e.g., basic text-based interface such as a chat interface). In an aspect, the present disclosure provides a hosted application 130 that can supplement a standard interface with re-usable user experience components.

In an aspect, the AI service 140 includes the host application 134, an orchestrator 142, a skill library 160, and the generative AI model 150. The AI service 140 may receive a first prompt 112 from the client application 132 or a user 105 thereof to the generative AI model 150. The AI service 140 may identify, by the generative AI, a first skill 162 from a skill library 160 that best answers the prompt 112. For example, the orchestrator 142 may use the generative AI model 150 to identify an intent of the prompt 112 and select a skill 162 based on the intent. In an aspect, a skill that is associated with a reusable user interface component includes a schema 164 that defines the skill. The orchestrator 154 may obtain a schema 164 for the first skill. The host application 134 may then return the schema 164 to a control loader 138 of the application 132. The control loader 138 may invokes pre-written code for the first skill with inputs specified in the schema 164 to generate a user interface component (e.g., UX component 114). For example, the schema 164 may identify the pre-written code in a content delivery network (CDN) for the application 132 to download and execute using the input identified in the schema 164.

The UX component 114 provides a user experience beyond the standard interface of the client application 132. For example, the UX component 114 may present content or interactive objects to the user 105. For instance, an interactive object may include a form with multiple embedded input mechanisms (e.g., text fields, menus, buttons, etc.) to both display output and receive input. As another example, the interactive object may include a display of an editable image with tools to perform an operation. For instance, the user may be asked to select portions of the image to perform an operation indicated in the prompt 112.

The control loader 138 returns a context 116 of the user experience to the host application 134. The context 116 may define events that occurred during the user experience. For instance, the events may include selection of controls, changes to an object, input from sensors (e.g., camera or microphone), etc. The context 116 for the skill 162 may be defined within the pre-written code for the skill 162. The context 116 allows the generative AI model 150 to respond to the user interactions in the UX component 114. For instance, the host application 134 may add the context 116 to the original prompt 112, and provide a supplemental prompt to the generative AI model 150. The orchestrator 142 may determine whether an intent of the original prompt 112 or a step of an execution plan is completed based on the context 116. The orchestrator 142 may perform further steps of the execution plan based on the context 116. For instance, the orchestrator 142 may select a second skill 162 based on the context 116. In some implementations, the orchestrator 142 may receive a second prompt 118 from the user 105, and select the second skill 152 based on the context 116 and the second prompt 118. For instance, the context 116 may provide input to the second skill based on the schema 164 of the second skill.

The possible user experiences of the UX component 114 can be expanded by adding skills to the skill library 160. Useful skills 162 may be applicable to multiple client applications 132. For instance, a skill that facilitates AI assisted editing of an image may be useful in a photo management application, a document creation application, an email application, or a presentation creation application. The same skill may be invoked by the different applications with the specific input for the application. Accordingly, the user experience can be customized for each application while having the efficiency of a single skill to develop and maintain.

The system 120 may provide one or more generative AI models 150 that are configured to receive prompts and output a response. In some implementations, the generative AI model 150 is an LLM. The LLM may be a specific instance or version of an LLM artificial intelligence that has been trained and fine-tuned on a large corpus of text. The LLM may be a Generalized Pre-trained Transformer (GPT) model. For example, a GPT model may include millions or billions of parameters trained on vast amounts of data (e.g., gigabytes or terabytes of text). A GPT model is a type of neural network that uses a transformer architecture to learn from large amounts of text data. The model has two main components: an encoder and a decoder. The encoder processes the input text and converts it into a sequence of vectors, called embeddings, that represent the meaning and context of each word. The decoder generates the output text by predicting the next word in the sequence, based on the embeddings and the previous words. The model uses a technique called attention to focus on the most relevant parts of the input and output texts, and to capture long-range dependencies and relationships between words. The model is trained by using a large corpus of texts as both the input and the output, and by minimizing the difference between the predicted and the actual words. The model can then be fine-tuned or adapted to specific tasks or domains, by using smaller and more specialized datasets.

In other implementations, the generative AI models 150 may be or include a multi-modal model or multiple models for different modes such as audio, images, or video. For instance, a diffusion model may be useful for generating images. A diffusion model is trained to learn a diffusion process for a dataset such that the process can generate new elements that are distributed similarly as the original dataset. Example commercially available diffusion models include Stable Diffusion and DALL-E. A generative AI model for video may be similar to a model for images, but also include an encoding in the time dimension.

One or more of the generative AI models 150 may provide an application programming interface (API) that allows other applications to interact with the respective generative AI model 150. For example, the API may allow a user or application to provide a prompt to the generative AI model 150. Prompts are the inputs or queries that a user or a program gives to the generative AI model 150, in order to elicit a specific response from the model. Prompts can be natural language sentences or questions, or code snippets or commands, or any combination of text or code, depending on the domain and the task. Prompts can also be nested or chained, meaning that the output of one prompt can be used as the input of another prompt, creating more complex and dynamic interactions with the model.

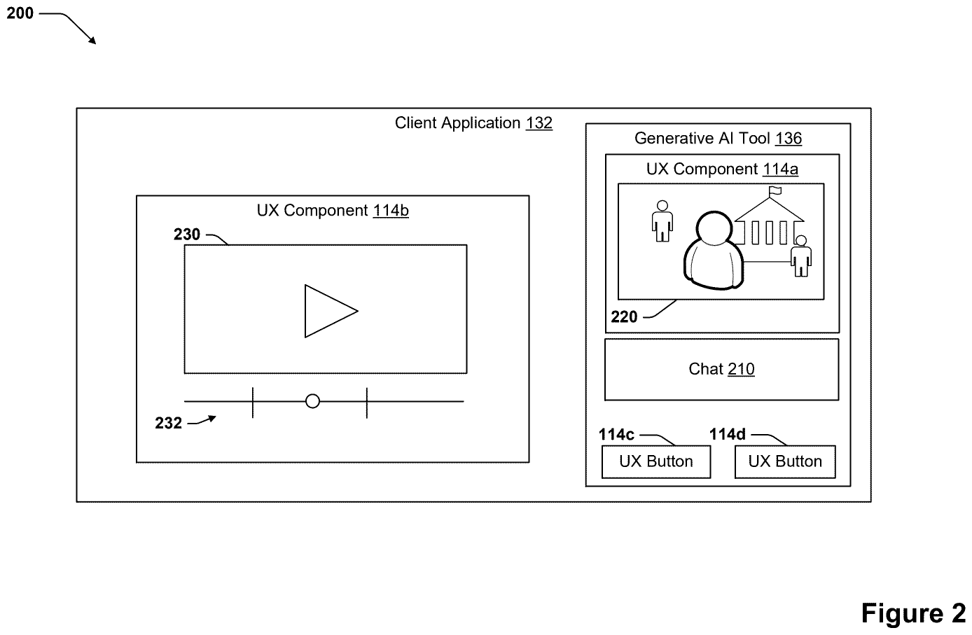

FIG. 2 is a diagram of a user interface 200 of an example client application 132 including examples of UX components 114. The client application 132 may be a client portion of a hosted application 130 that is installed on the user device 110. The user device 110 has a connection to the system 120 via the Internet. The client application 132 may communicate with the host application 134 portion of the hosted application 130. The client application 132 includes the generative AI tool 136. For example, the generative AI tool 136 may include code that is executed when the user accesses the generative AI tool 136. The generative AI tool 136 may generate a user interface component. For example, the user interface component may be a panel or window. In some implementations, a standard user interface for the generative AI tool 136 includes a chat interface that allows the user 105 to enter text and receive a response from the system 120.

In an aspect, the present disclosure provides for reusable user experience (UX) components that enhance the user interface 200 of the generative AI tool 136. In a first example, a UX component 114a is embedded within the user interface of the generative AI tool 136 (i.e., within a dedicated panel). For instance, the example UX component 114a is an image editor. The UX component 114a may obtain an image 220 from a file or camera of the user device 110. The UX component 114a may allow the user to perform an input using the image editor that may be difficult to input using text. For example, The UX component 114a may ask the user 105 to identify elements to remove from the image. The user 105 may select the elements by clicking or drawing an outline around the object. As discussed in further detail below, the UX component 114a may then provide context 116 of the UX component 114a to the system 120.

As another example, the UX component 114b may be displayed as a separate window or panel within the client application 132. The UX component 114b may be a video display and editing interface. For instance, the UX component 114b may present a video 230. The UX component 114b may include video controls 232 that allow the user 105 to perform operations such as play, pause, and skip. The video controls 232 may also allow the user 105 to set markers to indicate a particular frame. In an example use case, the UX component 114b may allow the user to edit a video clip for embedding within a presentation by viewing the video and selecting start and end points to create the video clip.

As another example, UX components 114c and 114d may be buttons that may be selected by the user. The specific functionality of the buttons may be determined by the UX components 114c and 114d, which may be dynamically loaded into the generative AI tool 136, for example, based on a prompt provided by the user 105. Accordingly, the user interface of the generative AI tool 136 may be dynamically adapted based on input from the user 105.

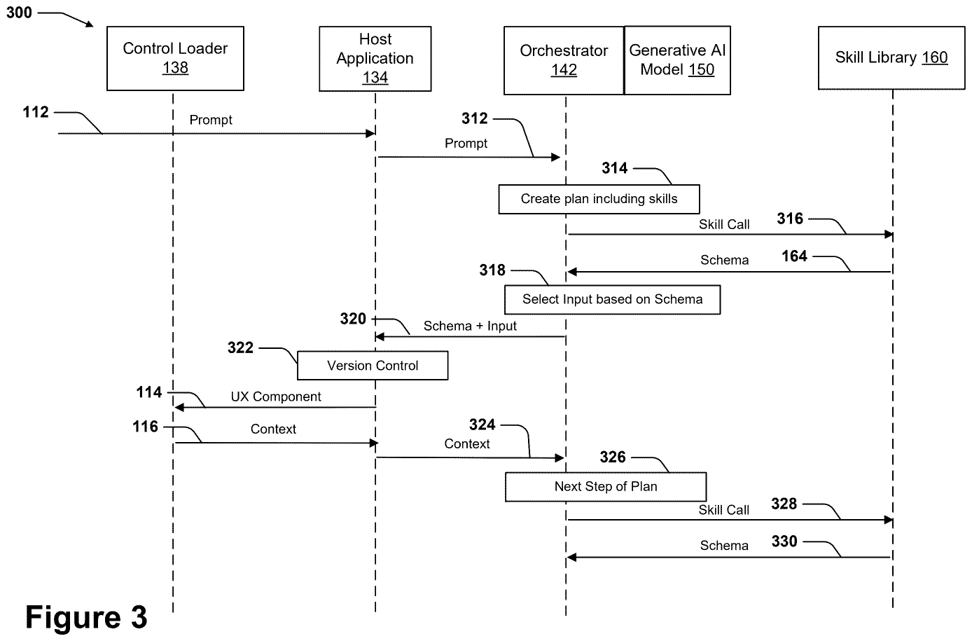

FIG. 3 is a message diagram 300 illustrating example communications of the system 120. The host application 134 may receive a prompt 112. For example, the prompt 112 may be received from the client device 110. The host application 134 may forward the prompt 112 to the orchestrator 142 as prompt 312. In some implementations, the host application 134 may add context to the prompt 312. For example, the host application 134 may identify the user 105, the client device 110, the client application 132, and/or previous actions of the user 105 with respect to the generative AI tool 136.

The orchestrator 142 may receive the prompt 312, and in block 314, create a plan including skills. The orchestrator 142 may use the Generative AI model 150 (e.g., an LLM) to generate the plan. For example, the plan may be a chain-of-thought produced by the generative AI model 150 when prompted with the prompt 312. The plan may identify one or more skills associated with the generative AI model 150. The orchestrator 142 may initiate a skill call 316 to the skill library for a first identified skill. In some implementations, where the skill does not involve a UX component, the skill library 160 may return the skill with no schema, and the orchestrator 142 may execute the skill via the generative AI model 150. When the skill is associated with a UX component, the skill library includes a schema 164 that defines the UX component for the first skill. For example, the schema 164 may include an identification of pre-written code for the UX component, inputs into the UX component, and/or a version number of the pre-written code. For example, the inputs into the UX component may be descriptions of parameters that are selected by the orchestrator 142. The identification of the pre-written code for the UX component may be a file name or content delivery network (CDN) identifier for the UX component. At block 318, the orchestrator 142 may select input based on the schema. For example, the schema may define a source for raw data such as a file name or address. The orchestrator 142 may populate the information indicated by the schema based on the prompt 312 or associated context. The orchestrator 142 may provide the schema and input 320 to the host application 134.

In some implementations, the host application 134 performs version control 322 on the schema and input 320. For instance, the host application 134 may check whether a version indicated in the schema 164 matches a version of a UX component installed at the control loader 138 and/or available from a CDN. The host application 134 may use the control loader 138 to execute the UX component 114 at the client device 110. For example, the host application 134 may initialize a runtime at the control loader 138, preload the UX component, and mount the UX component. The control loader 138 may then execute the UX component, and the user 105 may interact with the UX component.

The UX component 114 may generate context 116. The context 116 may include status events. Example status events related to a record include create, read, update, delete, error. Each event may include information about the changes made by the user 105. In some implementations, the UX component 114 may include a notify function that periodically submit context 116 to the system 120. In some implementations, a UX component 114 may execute a flush events function to immediately send context 116 to the system 120. In some implementations, the context 116 is in the form of a prompt. For example, the host application 134 may supplement the context 116 with information regarding the previous prompts (e.g., prompt 312). For instance, the host application 134 may send context 324, which includes the previous prompt 312 and the context 116.

When the orchestrator 142 receives the context 324, the orchestrator 142 may proceed with a next step of the plan at block 326. In some implementations, the orchestrator 142 and the generative AI model 150 may be able to answer the prompt 312 based on the additional context 116. In some implementations, the plan may include performing a second skill based on the context 116. For example, the orchestrator 142 may send a second skill call 328 to skill library 160 and receive a second schema 330 for a second UX component. The loading, execution, and receipt of context from the second UX component may follow the same procedure as described above with respect to the first UX component. The orchestrator 142 may perform additional skills until the plan for the prompt is complete.

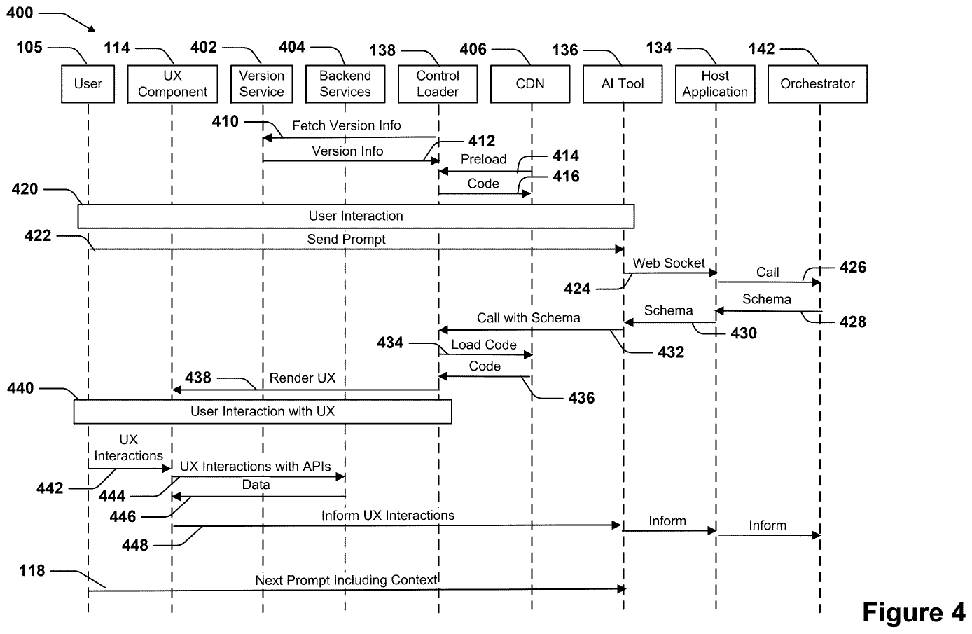

FIG. 4 is a message diagram 400 illustrating example communications of the user device 110. As discussed above with respect to FIG. 1, the user device 110 includes an AI tool 136 and a control loader. The user device 110 may communicate with various services, which may be hosted in the system 120 or as separate services. For example, the user device 110 may communicate with a version service 402, backend services 404, a content delivery network (CDN) 406, and the host application 134.

The control loader 138 may control execution of user interface components at the user device 110. During initialization, the control loader may fetch 410 version information 412 from the version service 402. The version service 402 is a service that provides current version information for software components such as the control loader 138 and UX components 114. The version information 412 can include current version numbers. The control loader 138 may also preload 414 necessary software components from the CDN 406. For example, the control loader 138 may receive code 416 for a user interface of the AI tool 136. The control loader 138 may also retrieve updated versions of components based on the version information 412.

At block 420, there is a user interaction with the AI tool 136. For example, the user 105 may be using the client application 132 and select the AI tool 136. The user 105 and/or the AI tool 136 may generate a prompt 112. For example, the AI tool 136 may include a chat interface 210 that allows the user 105 to send a prompt 422 to the AI tool 136. In other implementations, the AI tool 136 may automatically generate a prompt based on an action of the user 105. For example, the user 105 may select an action from a menu or by selecting a button.

The AI tool 136 may communicate with the host application 134 via a web socket 424. The AI tool 136 may submit the prompt 422 to the host application 134. From the perspective of the user device 110, the operations of the system 120 as described above with respect to FIG. 3 are mostly transparent. For instance, the web socket 424 may correspond to the prompt 112. The host application 134 may perform a call 426 (corresponding to the prompt 312) to the orchestrator 142 and receive the schema 428 (corresponding to schema and input 320).

The AI tool 136 receives the schema 430 as a definition of a UX component 114. The AI tool 136 uses the control loader 138 to load the UX component 114. For example, the AI tool 136 calls 432 the UX component 114 with the schema 430. The control loader 138 loads 434 code 436 for the UX component 114 from the CDN 406. In some implementations, the code 436 may be JavaScript. The control loader 138 executes the code 436 to render 438 the UX component 114.

At block 440, the user 105 interacts with the UX component 114. As discussed above with respect to FIG. 2, the UX component 114 can be configured to provide different user interactions 442 depending on the needs of the AI tool 136. In some implementations, the UX component 114 can be configured to perform UX interactions using APIs 444. For example, the user interaction may involve calling an API for a service of the system 120 or a third party service that provides data 446. In an aspect, the reusable UX components 114 of the present disclosure provide for full stack programmability of the user experience.

The UX component 114 informs 448 the AI tool 136 of the user interactions. As discussed above, the user interactions can be modeled as events and can be reported periodically or on demand. The individual UX component 114 may define the types of events reported and the information associated with the events. In some implementations, the events are reported in a JavaScript Object Notation (JSON) format or extensible markup language (XML) format. The AI tool 136 informs 450 the host application 134 of the user interactions, and the host application 134 informs 452 the orchestrator 142 of the user interactions. Accordingly, the AI tool 136 provides context 116 of the user interactions to the orchestrator 142 and/or the generative AI model 150. When the user 105 and/or the AI tool 136 generates a second prompt 118, the prompt includes the context 116 of the previous user interactions via the UX component 114. The addition of the context 116 to a user supplied second prompt 118 may be transparent to the user 105.

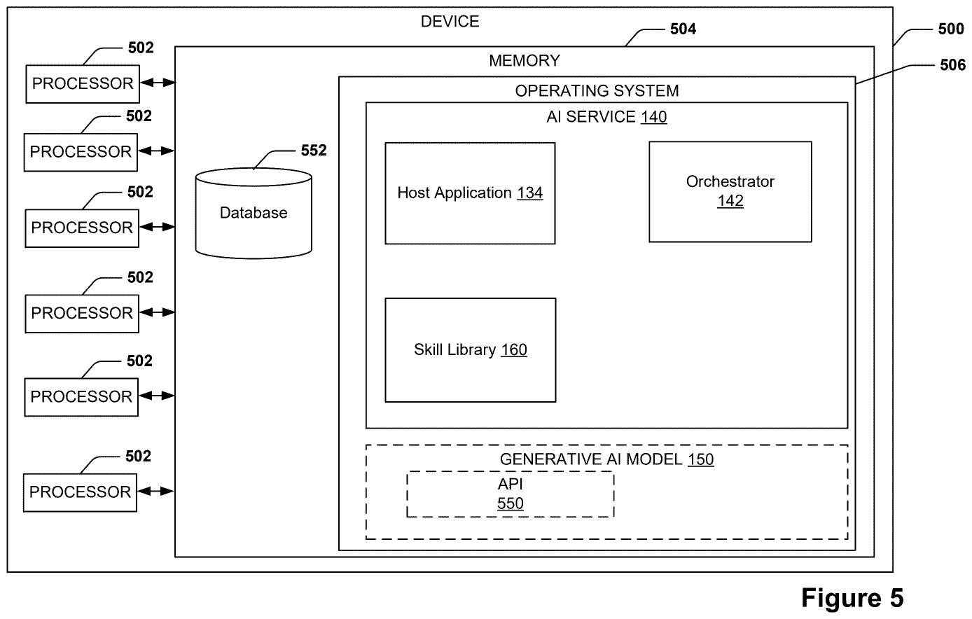

FIG. 5 is a schematic diagram of an example of an apparatus 500 (e.g., a computing device) for providing reusable user interface components for interaction with a generative AI model. The apparatus 500 may be implemented as one or more computing devices in the system 120.

In an example, the apparatus 500 includes at least one processor 502 and a memory 504 configured to execute or store instructions or other parameters related to providing an operating system 506, which can execute one or more applications or processes, such as, but not limited to, the AI service 140. For example, processors 502 and memory 504 may be separate components communicatively coupled by a bus (e.g., on a motherboard or other portion of a computing device, on an integrated circuit, such as a system on a chip (SoC), etc.), components integrated within one another (e.g., a processor 502 can include the memory 504 as an on-board component), and/or the like. Memory 504 may store instructions, parameters, data structures, etc. for use/execution by processor 502 to perform functions described herein. In some implementations, the memory 504 includes the database 552 for use by the AI service 140. In some implementations, the apparatus 500 includes the generative AI model 150, for example, as another application executing on the processors 502. Alternatively, the generative AI model 150 may be executed on a different device that may be accessed via an API 550.

In an example, the AI service 140 includes the host application 134, the orchestrator 142, and the skill library 160. In some implementations, the AI service 140 may include the version service 402, the backend services 404, and/or the CDN 406, or these services can be hosted on other devices.

In some implementations, the apparatus 500 is implemented as a distributed processing system, for example, with multiple processors 502 and memories 504 distributed across physical systems such as servers, virtual machines, or datacenters 122. For example, one or more of the components of the workflow automation application 130 may be implemented as services executing at different datacenters 122. The services may communicate via an API.

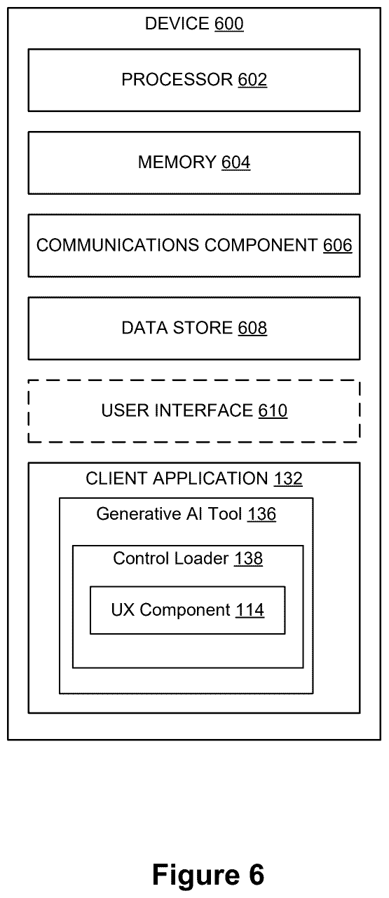

FIG. 6 illustrates an example of a user device 600. The user device 600 may be an example of the user device 110. In one aspect, device 600 includes processor 602, which may be similar to processor 502 for carrying out processing functions associated with one or more of components and functions described herein. Processor 602 can include a single or multiple set of processors or multi-core processors. Moreover, processor 602 can be implemented as an integrated processing system and/or a distributed processing system.

Device 600 further includes memory 604, which may be similar to memory 504 such as for storing local versions of operating systems (or components thereof) and/or applications being executed by processor 602, such as the client application 132 including the generative AI tool 136, the control loader 138, the UX component 114, etc. Memory 604 can include a type of memory usable by a computer, such as random access memory (RAM), read only memory (ROM), tapes, magnetic discs, optical discs, volatile memory, non-volatile memory, and any combination thereof. The processor 602 may execute instructions stored on the memory 604 to cause the device 600 to perform the methods discussed below with respect to FIGS. 7 and 8.

Further, device 600 includes a communications component 606 that provides for establishing and maintaining communications with one or more other devices, parties, entities, etc. utilizing hardware, software, and services as described herein. Communications component 606 carries communications between components on device 600, as well as between device 600 and external devices, such as devices located across a communications network and/or devices serially or locally connected to device 600. For example, communications component 606 may include one or more buses, and may further include transmit chain components and receive chain components associated with a wireless or wired transmitter and receiver, respectively, operable for interfacing with external devices.

Additionally, device 600 may include a data store 608, which can be any suitable combination of hardware and/or software, that provides for mass storage of information, databases, and programs employed in connection with aspects described herein. For example, data store 608 may be or may include a data repository for operating systems (or components thereof), applications, related parameters, etc. not currently being executed by processor 602. In addition, data store 608 may be a data repository for the client application 132.

Device 600 may optionally include a user interface component 610 operable to receive inputs from a user of device 600 and further operable to generate outputs for presentation to the user. User interface component 610 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 610 may include one or more output devices, including but not limited to a display, a speaker, a haptic feedback mechanism, a printer, any other mechanism capable of presenting an output to a user, or any combination thereof.

Device 600 additionally includes the client application 132 including the generative AI tool 136 for providing generative AI assistance to a user of the client application 132.

FIG. 7 is a flow diagram of an example of a method 700 for providing reusable user experience components for interaction with a generative AI. For example, the method 700 can be performed by the system 120, the apparatus 500 and/or one or more components thereof to provide UX components 114 that interact with the generative AI model 150.

At block 710, the method 700 includes receiving a first prompt from an application or a user thereof to a generative AI. For example, in an aspect, apparatus 500, processor 502, memory 504, and/or host application 134 may be configured to or may comprise means for receiving a first prompt from an application or a user thereof to a generative AI. For example, the host application 134 may receive a first prompt 112 from an application (e.g., client application 132) or a user 105 thereof to a generative AI (e.g., generative AI model 150).

At block 720, the method 700 includes identifying, by the generative AI, a first skill from a skill library that best answers the first prompt. For example, in an aspect, apparatus 500, processor 502, memory 504, and/or orchestrator 142 may be configured to or may comprise means for identifying, by an orchestration layer of the generative AI configured to generate an execution plan and chain-of-thought for the prompt, a first skill from a skill library that best answers the first prompt. For example, the orchestrator 142 may identify, using the generative AI model 150, a first skill 162 from a skill library 160 that best answers the first prompt 112. In some implementations, at sub-block 722, the block 720 may optionally include providing the first prompt to an orchestration layer (e.g., orchestrator 142) configured to generate an execution plan and chain-of-thought for the prompt 112 using the generative AI model 150.

At block 730, the method 700 includes obtaining a schema for the first skill. For example, in an aspect, apparatus 500, processor 502, memory 504, and/or the orchestrator 142 may be configured to or may comprise means for obtaining a schema for the first skill. For example, the orchestrator 142 may obtain the schema 164 for the first skill 162 from the skill library 160.

At block 740, the method 700 includes returning the schema to a control loader of the application that invokes pre-written code for the first skill with inputs specified in the schema to generate a user interface component. For example, in an aspect, apparatus 500, processor 502, memory 504, and/or the host application 134 may be configured to or may comprise means for returning the schema to a control loader of the application that invokes pre-written code for the first skill with inputs specified in the schema to generate a user interface component. For example, the host application 134 may return the schema 164 to a control loader 138 of the application 132 that invokes pre-written code for the first skill with inputs specified in the schema to generate a user interface component (e.g., UX component 114).

At block 750, the method 700 includes providing a context of the user interface component to the generative AI. For example, in an aspect, apparatus 500, processor 502, memory 504, and/or the host application 134 may be configured to or may comprise means for providing a context of the user interface component to the generative AI. For example, the host application 134 may provide a context 116 of the user interface component (e.g., UX component 114) to the generative AI model 150. For instance, the context 116 may be included in a second prompt to the generative AI model 150.

At block 760, the method 700 may optionally include receiving a second prompt from the user or the application. For example, in an aspect, apparatus 500, processor 502, memory 504, and/or the host application 134 may be configured to or may comprise means for receiving a second prompt from the user or the application. For example, the host application 134 may receive the second prompt 118 from the client application 132 or the user 105.

At block 770, the method 700 may optionally include identifying, by the generative AI, a second skill. Similar to block 720, the orchestrator 142 may identify the second skill by providing a prompt to the generative AI model 150. In some implementations, the orchestrator 142 may provide the first prompt 112 plus the context 116. In some implementations, for example, following block 760, the orchestrator 142 may provide the second prompt 118 plus the context 116.

At block 780, the method 700 may optionally include calling the second skill on the context of the user interface component. For example, in an aspect, apparatus 500, processor 502, memory 504, and/or the orchestrator 142 may be configured to or may comprise means for calling the second skill on the context of the user interface component. For example, the orchestrator 142 may send the second skill call 328 to the skill library. In some implementations, where the second skill does not include a schema, the orchestrator 142 may perform the second skill using the generative AI model 150. In some implementations, where the second skill includes a schema 164, the orchestrator may return the schema 164 to the control loader 138 to invoke pre-written code for the second skill in a similar manner as in block 740.

In an aspect, the method 700 may optionally include repeating blocks 760, 770, and/or 780 for additional skills until a plan for the first prompt 112 is completed.

FIG. 8 is a flow diagram of an example of a method 800 for presenting reusable user experience components for interaction with a generative AI. For example, the method 800 can be performed by the user device 110, the device 600 and/or one or more components thereof to present UX components 114 that interact with the generative AI model 150.

At block 810, the method 800 includes executing an application having an interface with a generative AI. For example, in an aspect, device 600, processor 602, memory 604, and/or client application 132 may be configured to or may comprise means for executing an application having an interface with a generative AI. For example, the processor 602 may execute the client application 132 having the AI tool 136 for interacting with the generative AI model 150.

At block 820, the method 800 includes sending a prompt from the application to network service hosting the generative AI. For example, in an aspect, device 600, processor 602, memory 604, and/or client application 132 may be configured to or may comprise means for sending a prompt from the application to network service hosting the generative AI. For example, the processor 602 may execute the client application 132 to send a prompt 112 from the client application 132 to the network service (e.g., AI service 140) hosting the generative AI model 150. For example, the client application 132 may include a network socket with the network application 134.

At block 830, the method 800 includes receiving a schema specifying pre-written code for a user interface component and input to the user interface component selected by the generative AI. For example, in an aspect, device 600, processor 602, memory 604, and/or client application 132 may be configured to or may comprise means for receiving a schema specifying pre-written code for a user interface component and input to the user interface component selected by the generative AI. For example, the processor 602 may execute the client application 132 to receive (e.g., via a network socket) the schema 164 specifying pre-written code for a user interface component and input to the user interface component selected by the generative AI.

At block 840, the method 800 includes executing the user interface component to interact with a user of the apparatus. For example, in an aspect, device 600, processor 602, memory 604, and/or client application 132 may be configured to or may comprise means for executing the user interface component to interact with a user of the apparatus. For example, the processor 602 may execute the control loader 138 to execute the user interface component (e.g., UX component 114) to interact with the user 105 of the apparatus. In some implementations, at sub-block 842, the block 840 optionally includes comparing a version of the pre-written code for the user interface component with a version indicated by the schema. In some implementations, at sub-block 844, the block 840 optionally includes selecting the pre-written code from a content delivery network.

At block 850, the method 800 includes informing the generative AI of context of the user interactions. For example, in an aspect, device 600, processor 602, memory 604, and/or client application 132 may be configured to or may comprise means for informing the generative AI of context of the user interactions. For example, the processor 602 may execute the client application 132 to inform the generative AI model 150 of context 116 of the user interactions. For example, the UX component 114 may generate events that the client application 132 reports to the generative AI model 150.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer-readable media excludes transitory signals.

The following numbered clauses provide an overview of aspects of the present disclosure:

Clause 1. An apparatus, comprising: one or more memories storing computer executable instructions; and one or more processors coupled with the one or more memories and, individually or in combination, configured to: execute an application having an interface with a generative artificial intelligence (AI); send a prompt from the application to a network service hosting the generative AI; receive a schema specifying pre-written code for a user interface component and input to the user interface component selected by the generative AI; execute the user interface component to interact with a user of the apparatus; and inform the generative AI of context of the user interactions.

Clause 2. The apparatus of clause 1, wherein to execute the user interface component, the one or more processors are configured to: compare a version of the pre-written code for the user interface component with a version indicated by the schema; and select the pre-written code from a content delivery network (CDN).

Clause 3. The apparatus of clause 1 or 2, wherein the schema includes: an identification of the pre-written code; the inputs; and a version number of the pre-written code.

Clause 4. The apparatus of any of clauses 1-3, wherein the context of the user interface component includes the inputs specified in the schema and one or more status changes made via the user interface component.

Clause 5. The apparatus of any of clauses 1-4, wherein the pre-written code for the user interface component includes one or more calls to an application programming interface (API) of a network service.

Clause 6. An apparatus, comprising: one or more memories storing computer executable instructions; and one or more processors coupled with the one or more memories and, individually or in combination, configured to: receive a first prompt from an application or a user thereof to a generative artificial intelligence (AI); identify, by an orchestration layer of the generative AI configured to generate an execution plan and chain-of-thought for the prompt, a first skill from a skill library that best answers the prompt; obtain a schema for the first skill; return the schema to a control loader of the application that invokes pre-written code for the first skill with inputs specified in the schema to generate a user interface component; and provide a context of the user interface component to the generative AI.

Clause 7. The apparatus of clause 6, wherein the first prompt is received via an interface between the application and the generative AI.

Clause 8. The apparatus of clause 6 or 7, wherein the control loader is configured to compare a version of the pre-written code for the first skill with a version indicated by the schema and select the pre-written code from a content delivery network (CDN).

Clause 9. The apparatus of any of clauses 6-8, wherein the schema includes: an identification of the pre-written code; the inputs; and a version number of the pre-written code.

Clause 10. The apparatus of any of clauses 6-9, wherein the context of the user interface component includes the inputs specified in the schema and one or more status changes made via the user interface component.

Clause 11. The apparatus of any of clauses 6-10, wherein the one or more processors are further configured to: identify, by the generative AI, a second skill; and call the second skill on the context of the user interface component.

Clause 12. The apparatus of clause 11, wherein the one or more processors are further configured to receive a second prompt from the user or the application, wherein the second skill is identified based on the second prompt and the context of the user interface component.

Clause 13. The apparatus of clause any of clauses 6-12, wherein the pre-written code for the first skill includes one or more calls to an application programming interface (API) of a network service.

Clause 14. A method comprising: receiving a first prompt from an application or a user thereof to a generative artificial intelligence (AI); identifying, by an orchestration layer of the generative AI configured to generate an execution plan and chain-of-thought for the prompt, a first skill from a skill library that best answers the first prompt; obtaining a schema for the first skill; returning the schema to a control loader of the application that invokes pre-written code for the first skill with inputs specified in the schema to generate a user interface component; and providing a context of the user interface component to the generative AI.

Clause 15. The method of clause 14, wherein the prompt is received via an interface between the application and the generative AI.

Clause 16. The method of clause 14 or 15, wherein identifying the first skill comprises providing the first prompt to an orchestration layer configured to generate an execution plan and chain-of-thought for the prompt using the generative AI.

Clause 17. The method of any of clauses 14-16, wherein the control loader is configured to compare a version of the pre-written code for the first skill with a version indicated by the schema and select the pre-written code from a content delivery network (CDN).

Clause 18. The method of any of clauses 14-17, wherein the schema includes: an identification of the pre-written code; the inputs; and a version number of the pre-written code.

Clause 19. The method of any of clauses 14-18, wherein the context of the user interface component includes the inputs specified in the schema and one or more status changes made via the user interface component.

Clause 20. The method of any of clauses 14-19, further comprising: identifying, by the generative AI, a second skill; and calling the second skill on the context of the user interface component.

Clause 21. The method of clause 20, further comprising: receiving a second prompt from the user or the application, wherein the second skill is identified based on the second prompt and the context of the user interface component.

Clause 22. The method of any of clauses 14-21, wherein the pre-written code for the first skill includes one or more calls to an application programming interface (API) of a network service.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus, comprising:
one or more memories storing computer executable instructions; and
one or more processors coupled with the one or more memories and, individually or in combination, configured to:
execute an application having an interface with a generative artificial intelligence (AI);
send a prompt from the application to a network service hosting the generative AI;
receive a schema specifying pre-written code for a user interface component and input to the user interface component selected by the generative AI;
execute the user interface component to interact with a user of the apparatus; and
inform the generative AI of context of the user interactions.

2. The apparatus of claim 1, wherein to execute the user interface component, the one or more processors are configured to:
compare a version of the pre-written code for the user interface component with a version indicated by the schema; and
select the pre-written code from a content delivery network (CDN).

3. The apparatus of claim 1, wherein the schema includes: an identification of the pre-written code; the inputs; and a version number of the pre-written code.

4. The apparatus of claim 1, wherein the context of the user interface component includes the inputs specified in the schema and one or more status changes made via the user interface component.

5. The apparatus of claim 1, wherein the pre-written code for the user interface component includes one or more calls to an application programming interface (API) of a network service.

6. An apparatus, comprising:
one or more memories storing computer executable instructions; and
one or more processors coupled with the one or more memories and, individually or in combination, configured to:
receive a first prompt from an application or a user thereof to a generative artificial intelligence (AI);
identify, by an orchestration layer of the generative AI configured to generate an execution plan and chain-of-thought for the prompt, a first skill from a skill library that best answers the prompt;
obtain a schema for the first skill;
return the schema to a control loader of the application that invokes pre-written code for the first skill with inputs specified in the schema to generate a user interface component; and
provide a context of the user interface component to the generative AI.

7. The apparatus of claim 6, wherein the first prompt is received via an interface between the application and the generative AI.

8. The apparatus of claim 6, wherein the control loader is configured to compare a version of the pre-written code for the first skill with a version indicated by the schema and select the pre-written code from a content delivery network (CDN).

9. The apparatus of claim 6, wherein the schema includes: an identification of the pre-written code; the inputs; and a version number of the pre-written code.

10. The apparatus of claim 6, wherein the context of the user interface component includes the inputs specified in the schema and one or more status changes made via the user interface component.

11. The apparatus of claim 6, wherein the one or more processors are further configured to:
identify, by the generative AI, a second skill; and
call the second skill on the context of the user interface component.

12. The apparatus of claim 11, wherein the one or more processors are further configured to receive a second prompt from the user or the application, wherein the second skill is identified based on the second prompt and the context of the user interface component.

13. The apparatus of claim 6, wherein the pre-written code for the first skill includes one or more calls to an application programming interface (API) of a network service.

14. A method comprising:
receiving a first prompt from an application or a user thereof to a generative artificial intelligence (AI);
identifying, by an orchestration layer of the generative AI configured to generate an execution plan and chain-of-thought for the prompt, a first skill from a skill library that best answers the first prompt;
obtaining a schema for the first skill;
returning the schema to a control loader of the application that invokes pre-written code for the first skill with inputs specified in the schema to generate a user interface component; and
providing a context of the user interface component to the generative AI.

15. The method of claim 14, wherein the prompt is received via an interface between the application and the generative AI.

16. The method of claim 14, wherein identifying the first skill comprises providing the first prompt to an orchestration layer configured to generate an execution plan and chain-of-thought for the prompt using the generative AI.

17. The method of claim 14, wherein the control loader is configured to compare a version of the pre-written code for the first skill with a version indicated by the schema and select the pre-written code from a content delivery network (CDN).

18. The method of claim 14, wherein the schema includes: an identification of the pre-written code; the inputs; and a version number of the pre-written code.

19. The method of claim 14, wherein the context of the user interface component includes the inputs specified in the schema and one or more status changes made via the user interface component.

20. The method of claim 14, further comprising:
identifying, by the generative AI, a second skill; and
calling the second skill on the context of the user interface component.

21. The method of claim 20, further comprising:
receiving a second prompt from the user or the application, wherein the second skill is identified based on the second prompt and the context of the user interface component.

22. The method of claim 14, wherein the pre-written code for the first skill includes one or more calls to an application programming interface (API) of a network service.
